(19) United States
(12) Patent Application Publication
(10) Pub. No.: US 2020/0346589 A1
(43) Pub. Date: Nov. 5, 2020

(54) TELECAMERA FOR A VEHICLE AND FASTENING OF A TELECAMERA TO THE VEHICLE

(71) Applicant: Conti Temic microelectronic GmbH, Numberg (DE)

(72) Inventors: Martin Grünwald, Ulm (DE); Franz Pfeiffer, Ulm (DE)

(73) Assignee: Conti Temic microelectronic GmbH, Nurnberg (DE)

(21) Appl. No.: 16/929,263

(22) Filed: Jul. 15, 2020

Related U.S. Application Data
(63) Continuation of application No. PCT/DE2019/200005, filed on Jan. 31, 2019.

(30) Foreign Application Priority Data
Feb. 13, 2018 (DE) 10 2018 202 205.4

(51) Int. Cl. B60R 11/04; G02B 13/02; H04N 5/225

(52) U.S. Cl. CPC B60R 11/04; H04N 5/2254; G02B 13/02

(57) ABSTRACT

A camera device for a vehicle includes an objective and an image sensor housing mechanically connected thereto. The objective is a telephoto lens. The telephoto lens includes a positioning element which enables the camera device to be fastened in an orientation predetermined by the positioning element of the telephoto lens. A fastening device for receiving and fixing such a camera device to a camera mount on a vehicle is also disclosed.

### CROSS REFERENCE TO RELATED APPLICATION

This application is a continuation of International application No. PCT/DE2019/200005, filed Jan. 31, 2019, which claims priority to German patent application No. 10 2018 202 205.4, filed Feb. 13, 2018, each of which is hereby incorporated by reference.

### TECHNICAL FIELD

The technical field relates generally to a telecamera for a vehicle and a possibility of fastening a telecamera to the vehicle.

### BACKGROUND

Driver assistance systems in vehicles frequently use a camera system for recognizing objects in the environment of the vehicle, for example in a surrounding region lying ahead in the direction of travel. Such camera systems are, e.g., arranged in the interior of the vehicle behind the windshield and look through the window in the direction of travel.

Some driver assistance systems require information regarding objects which are located a long way in front of the vehicle. Such objects cannot always be reliably sensed and recognized with conventional wide-angle cameras (aperture angle typically >50 degrees).

German patent publication No. DE 101 62 652 A1 shows a stereo camera arrangement in a vehicle, in particular for classifying objects and determining distance. In order to ensure that the camera system is securely received and accurately positioned, in particular fixed in a lateral position, a camera arrangement is provided which has at least two camera modules, a bracket in which camera modules are received at a predetermined lateral distance in relation to each other, wherein the holding apparatus is stuck to the inner side of the windshield. For mounting purposes, a snap-in or respectively snap-fit mechanism can, by way of example, be provided in the bracket for receiving the camera modules, in by way of example their objective region, in order to ensure secure positioning and firm seating.

International patent publication No. WO 2011/107071 A1 shows an optical device for a semiconductor camera and a method for aligning and fixing an optical device for a semiconductor camera. An optical device according to the invention has a carrier having at least one rotationally symmetric opening and at least one camera module. The camera module comprises an image sensor, at least one lens, and a module housing having a housing opening, through which electromagnetic radiation can reach the image sensor, wherein the module housing is constructed rotationally symmetrically at least in one region between the housing opening and the image sensor so that the camera module can be mounted in the opening of the carrier.

A large number of cameras in and on the vehicle are required for automated driving. The requirements of individual camera modules are different and, in part, highly specialized.

As such, it is desirable to present an improved camera device. In addition, other desirable features and characteristics will become apparent from the subsequent summary and detailed description, and the appended claims, taken in conjunction with the accompanying drawings and this background.

### SUMMARY

Satellite cameras known in principle from surround view (panoramic view camera systems) constitute a starting point for the solution. While panoramic view camera modules are, as a general rule, installed on the exterior of a vehicle, a fastening in the vehicle interior is sought in this case.

In particular, a satellite camera denotes a camera without an integrated image evaluation unit. The satellite camera comprises an objective, an image sensor (imager) and an output connection, via which the captured images can be transmitted as a raw image signal to an external image evaluation unit, e.g., a central control unit (ECU).

A first aspect consists of providing a camera which can reliably image objects located in the distance. A telephoto lens, which makes possible a high resolution within a narrow viewing angle range, is used for this purpose. Telecameras have not previously been deployed as standard in vehicles for detecting the vehicle environment.

During the development of solutions for using such cameras in or on the vehicle, fault tolerances are problematic, since small angle deviations of the camera from the vehicle guarantee that the detection range of the telecamera no longer coincides with the intended detection range (area of interest). In the case of cameras having a wider detection angle, the camera housing is typically fastened by a bracket to the vehicle or respectively to the windshield. A displacement of the detection range is not critical to such an extent here since the detection range still covers the vast majority of the area of interest. The displacement can be compensated for within the context of the image processing without major problems. On the other hand, this is not possible with telecameras.

In addition, the significantly larger dimensions and the significantly higher weight of telephoto lenses, compared with objectives having a wider angle, are problematic. The connection between the objective and the camera housing has to be more stable. The objective protrudes a long way from the camera housing and, possibly, the camera housing bracket.

A camera device for a vehicle is proposed. For example, the camera device is configured to detect the surroundings, in particular to detect the surrounding region lying ahead of or behind the ego vehicle.

The camera device comprises an objective and an image sensor housing mechanically connected thereto. The objective comprises at least one lens, preferably multiple lenses, and a lens holder, wherein the lens holder in particular simultaneously forms the object housing. The objective is a telephoto lens, it preferably has an aperture angle of a maximum of 35 degrees or respectively at least a focal length of 70 mm. Detection ranges of at least 10 m to 50 m, preferably 10 m to 100 m or, especially, 10 m to 250 m are preferably focused onto the image sensor by the telephoto lens. The image sensor housing has an electrical connection facility for transmitting an image signal. The telephoto lens has a positioning element which makes possible fastening in an orientation of the telephoto lens predetermined by the positioning element. The fact that the telephoto lens is mechanically connected to the image sensor housing means that the orientation of the image sensor housing is advantageously predetermined by the fastening of the positioning element of the telephoto lens in a corresponding fastening device.

The camera device preferably has optics for projecting light and an image sensor for detecting the light projected by the optics. The camera device may be a vehicle camera to be mounted in the vehicle interior behind a windscreen or rear window, consequently directed in the direction of travel or in the direction opposite thereto.

The camera device is or can be mounted in particular by means of a fastening device on the inside of a vehicle window, especially a windshield of the ego vehicle. The fastening device is or can be connected, e.g., bonded directly to the inside of the vehicle window.

The camera device is or respectively can be mounted in the wiping region of at least one windshield wiper.

In one embodiment, the camera device does not include an image evaluation unit in order to ensure the compactness of the camera device. The camera device can, in this case, be referred to as a satellite camera. The captured images are transmitted by means of a fast data connection to an external image evaluation unit. For example, the image evaluation unit is a central driver assistance or respectively “automated driving” ECU (electronic control unit) of the ego vehicle. However, it is also possible that an image evaluation unit is integrated into the camera device; this is preferably limited to a few image evaluation functions.

One advantage of a camera device as described herein is that the tolerance chain of the optical axis is minimized in the direction of the vehicle axis or respectively of the fastening device to the vehicle. The fastening to the objective reduces stresses which would otherwise occur at the image sensor housing, if the latter were to have to carry the heavy telephoto lens. Stresses at the end of the objective are likewise minimized.

The positioning element of the telephoto lens may be a flange.

The positioning element may be configured as an integral part of the objective, that is to say, e.g., configured from the material of the lens holder of the objective. In other words, the lens holder and positioning element have an integral design.

According to one exemplary configuration, the positioning element has at least one stop surface perpendicular to the optical axis of the telephoto lens. This stop surface advantageously causes an adjustment of the pitch and yaw angles of the camera device with respect to a receiving or respectively fastening device and, consequently, with respect to the vehicle, to which the receiving or respectively fastening device is or respectively will be fixed.

The positioning element may include at least one stop surface parallel to the optical axis of the telephoto lens. This stop surface advantageously causes an adjustment of the roll angle of the camera device with respect to the receiving/fastening device or respectively the vehicle.

The positioning element may have two stop surfaces approximately at right angles to one another (80 to 100°), which both run parallel to the optical axis of the telephoto lens. The telephoto lens can be fastened spatially oriented in all degrees of freedom by means of three stop surfaces which are approximately perpendicular to one another.

A further subject-matter of the disclosure is a fastening device (e.g., a bracket) for receiving and fixing a corresponding camera device. The fastening device itself can be or become fastened, e.g., bonded, to a vehicle window. The orientation of the camera device with respect to the vehicle window is (substantially) defined by the connection to the positioning element of the telephoto lens of the camera device. The connection can be affected both positively, e.g., by at least one stop surface of the positioning element resting on a corresponding receiving surface of the fastening device, and non-positively, if a spring of the fastening device causes the stop surface of the positioning element to be squeezed onto the corresponding receiving surface of the fastening device.

In order to minimize the remaining tolerances when fastening the camera in the fastening device, a flexible system may be used in order to compensate for the remaining tolerances of the image sensor housing.

The fastening device may include at least one first spring which, in the assembled condition, causes the stop surface to be pressed onto a corresponding surface of the fastening device perpendicularly to the optical axis of the camera device. This advantageously defines pitch and yaw angles. The image sensor housing is advantageously only contacted by this at least one first spring on the part of the fastening device.

The fastening device may include at least one second spring which causes the stop surface(s) to be or become pressed onto one or respectively two corresponding surface(s) of the fastening device parallel to the optical axis of the camera device. This defines the roll angle in particular. The second spring advantageously only contacts the positioning device.

Finally, the disclosure relates to a camera mount on a vehicle by means of such a fastening device and such a camera device.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 shows an objective and an image sensor housing of a camera device which can be fastened in accordance with the prior art as individual parts;

FIG. 2 shows the assembled camera device in a fastening device in accordance with the prior art;

FIG. 3 shows a camera device fastened in accordance with the prior art in the nominal condition and in the condition having maximum tolerance;

FIG. 4 shows the repercussion of displacing the optical axis and the detection range with respect to the area of interest of a camera device fastened in accordance with the prior art in the nominal condition and in the condition having maximum tolerance;

FIG. 5 shows an embodiment example of a telephoto lens and of an image sensor housing of a camera device which can advantageously be fastened as individual parts;

FIG. 6 shows the assembled camera device in an optimized fastening device;

FIG. 7 shows a camera device fastened in an optimum manner in the nominal condition and in the condition having maximum tolerance;

FIG. 8 shows the repercussion of displacing the optical axis and the detection range with respect to the area of interest of the camera device fastened in an optimum manner in the nominal condition and in the condition having maximum tolerance;

FIG. 9a shows stop surfaces of the positioning element on the telephoto lens of the camera device for angle-optimized fastening;

FIG. 9b shows a vehicle having rotating axes;

FIG. 10 shows a side view of a windshield having a fastening/receiving device, camera device, and fastening lid bracket;

FIG. 11 shows a perspective view of a fastening/receiving device, camera device, and fastening lid bracket;

FIG. 12 shows a perspective view of the windshield having the cut-open fastening/receiving device, camera device, and fastening lid bracket; and

FIG. 13 shows a cross-sectional view of the windshield having the joined-together fastening/receiving device, camera device and fastening lid bracket with springs.

### DETAILED DESCRIPTION

Parts corresponding to one another are, as a general rule, provided with the same reference numerals in all figures.

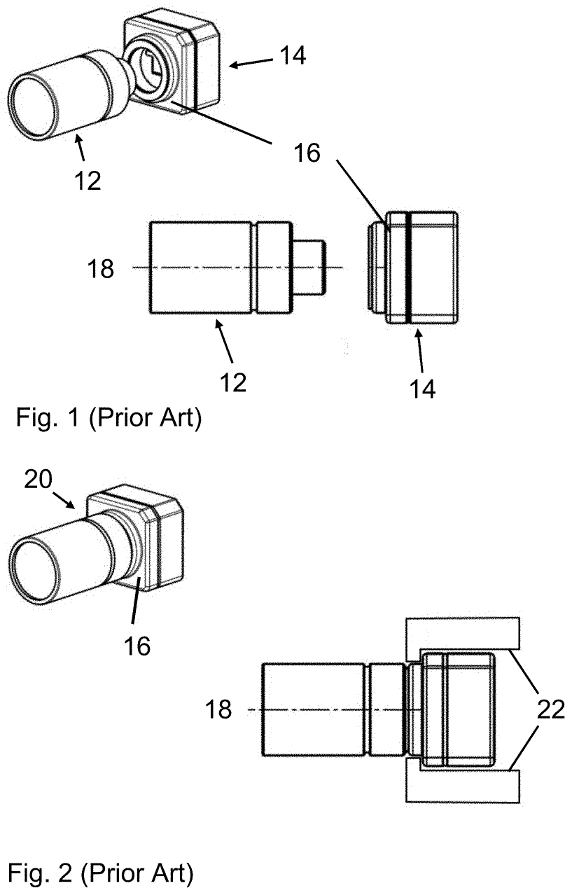

FIG. 1 shows an objective 12 and an image sensor housing 14 of a camera device 20 as individual parts in a three-dimensional representation (top left). The camera device is positioned by means of an alignment of one or more surfaces 16 of the image sensor housing. At the bottom of FIG. 1, a lateral view of the objective 12 and image sensor housing 14 can be seen. The optical axis 18 is depicted as a dotdashed line. In the interior of the image sensor housing 14, there is located the image sensor, e.g. a CMOS sensor, which is not depicted. The image data are output and transmitted to an external processing unit.

FIG. 2 shows the camera device 20 which is assembled from the objective 12 and image sensor housing 14 in a three-dimensional view (top left). The camera device 20 is fastened in a fastening device 22 in accordance with the prior art (bottom right).

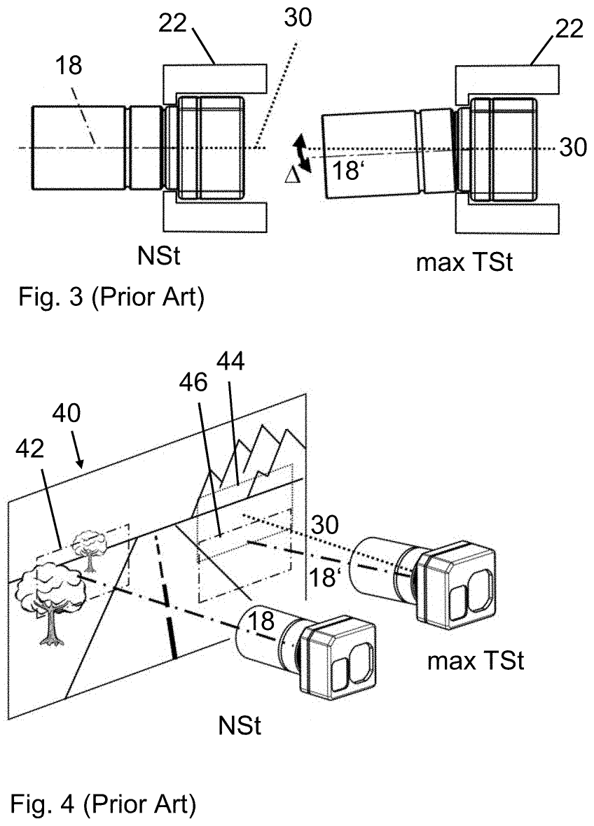

FIG. 3 shows, on the left, a camera device 20 in the nominal condition (NSt), which is fastened in accordance with the prior art. The central axis 30, which predetermines the fastening device 22, is depicted as a dotted line and coincides with the optical axis 18 of the objective 12 of the camera device 20. On the right, a camera device 20 in the condition having maximum tolerance (max TSt) is depicted fastened in a fastening device 22 in accordance with the prior art. In the condition of maximum tolerance (max TSO, the objective 12 is tilted with respect to the image sensor housing 14. Since the camera device 20 is fastened above the plane(s) 16 of the image sensor housing 14 in the fastening device 22, this results in a deviation A of the optical axis 18′ of the camera device 20 with respect to the central axis 30 of the fastening device 22.

FIG. 4 illustrates the repercussion of displacing the optical axis 18′ of the camera device 20 in the condition having maximum tolerance (max TSt), which is fastened in accordance with the prior art. The left camera device in the nominal condition (NSt) detects the region 42 from the vehicle surroundings 40 and images said detection range in a focused manner. In the nominal condition (NSt), with the described fastening, the optical axis 18 and the central axis 30 of the fastening device 22 coincide. On the other hand, a camera device 20 in the condition having maximum tolerance (max TSt) is depicted on the right, in which the optical axis 18′ and the central axis 30 of the fastening device 22 deviate from each other, as explained above, due to the fastening to the image sensor housing 14. Contrary to the intended area of interest 44, this causes a significantly displaced region 46 to be imaged by the image sensor. In the representation according to FIG. 4, the pitch angle deviation results in a surrounding region 46 located closer to the vehicle being imaged. As a result, objects in the more remote surrounding region 44 of actual interest cannot be imaged or cannot be imaged completely.

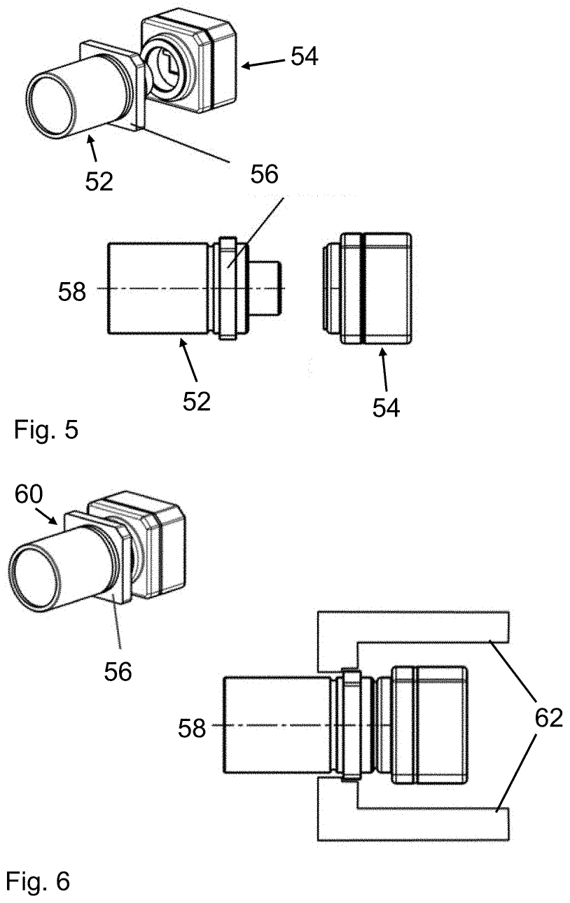

FIG. 5 shows a first schematic representation of an embodiment example of a camera device 60 made up of the individual parts of telephoto lens 52 and image sensor housing 54. The manner of representation is comparable to that in FIG. 1. The difference is that the telephoto lens 52 has a positioning element 56. The optical axis 58 of the telephoto lens 52 is depicted at the bottom as a dotdashed line. The positioning element 56 is a flange which has multiple stop surfaces, as a result of which an exact alignment in terms of the roll, pitch and yaw angles is made possible.

FIG. 6 shows the assembled camera device 60 in a spatial representation (top left). At the bottom right there is a lateral representation of the camera device 60 which is held in a fastening device 62 by the positioning element 56 on the telephoto lens.

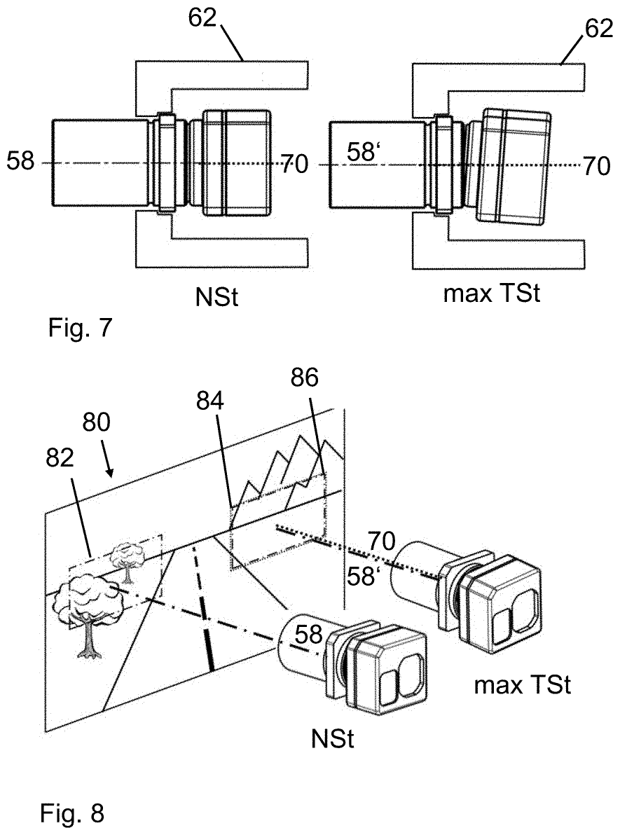

FIG. 7 shows for this type of fastening, on the left, a camera device in the nominal condition (NSt) and, on the right, a camera device in the condition having maximum tolerance (max TSt). Although the tilt between the telephoto lens 52 and the image sensor housing 54 of the right camera device 60 is comparable to the corresponding camera device 20 (max TSt) shown in FIG. 3, the deviation of the optical axis 58′ with respect to the central axis of the fastening device 62 is minimal, since the fastening is now effected at the positioning element 56 of the telephoto lens 52.

FIG. 8 illustrates the significantly lesser repercussion of displacing the optical axis and the detection range (82 or respectively 86) with respect to the area of interest 84. A camera device 60 in the nominal condition (NSt) is depicted on the left, and in the condition having maximum tolerance (max TSt) on the right.

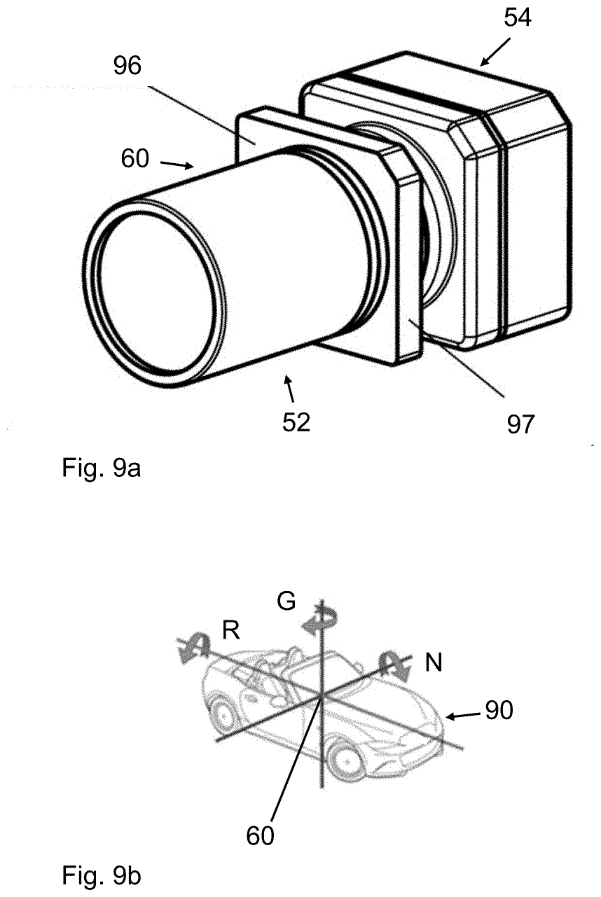

FIG. 9a shows the camera device 60 having the telephoto lens 52 and image sensor housing 54 in a spatial representation. The stop surface 96 serves to precisely orient the camera device 60 with respect to the pitch and yaw angles during the fastening. The stop surface 97 is used to align the roll angle during the fastening. In addition to the vertical stop surface 97, a horizontal stop surface (e.g. the upper or the lower horizontal surface of the flange) is also used to align the roll angle in a stable manner. For example, a spring force can cause the positioning element 56 of the telephoto lens 52 to be squeezed down to the left (viewed from the image sensor) against corresponding receiving surfaces.

FIG. 9b illustrates the three rotational axes of a camera device 60 fastened in a vehicle 90, The roll movement R takes place approximately around the vehicle longitudinal axis, the yaw movement G takes place around the vehicle vertical axis and the pitch movement N takes place around the vehicle transverse axis.

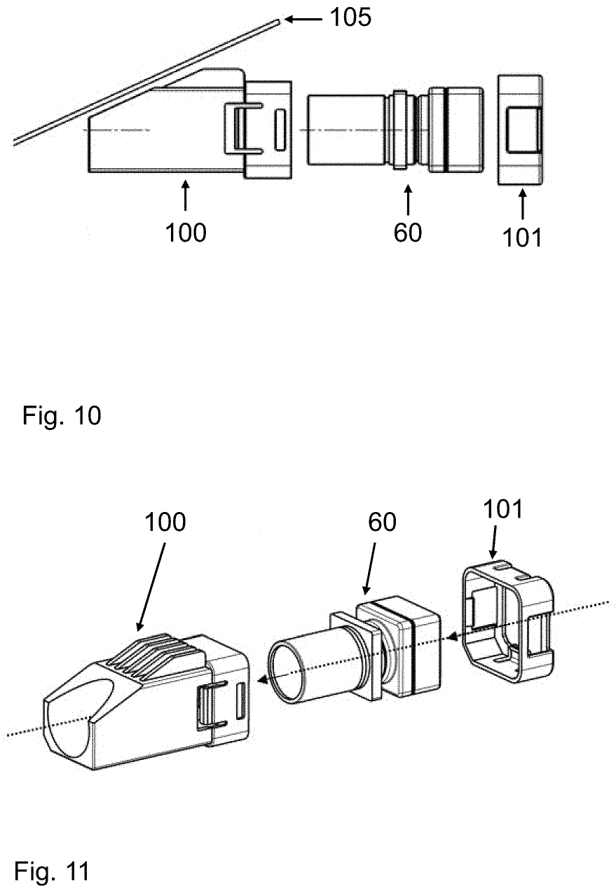

FIG. 10 shows a lateral view of a fastening/receiving device 100 glued to a windshield 105 of a vehicle, into which the camera device 60 is inserted. Since the fastening/receiving device 100 is initially fixed to the windshield 105, the camera device 60 is inserted from “behind” (towards the windshield 105) into the fastening/receiving device 100. The electrical connection and the fastening of the camera device 60 in the fastening/receiving device 100 are also affected at the back of the camera device 60 or respectively of the image sensor housing 54. Subsequently, the camera device 60 is fastened by a fastening lid bracket 101. The fastening lid bracket 101 has springs in the interior, which squeeze the camera device 60 against the fastening/receiving device 100 such that the stop surface(s) define(s) the orientation. The springs serve as a compensating element: remaining tolerances of the camera device 60 are minimized. In the fastened condition, the fastening lid bracket 101 engages on the fastening/receiving device 100.

FIG. 11 shows a perspective representation of a fastening/receiving device 100, camera device 60 and fastening lid bracket 101 having springs.

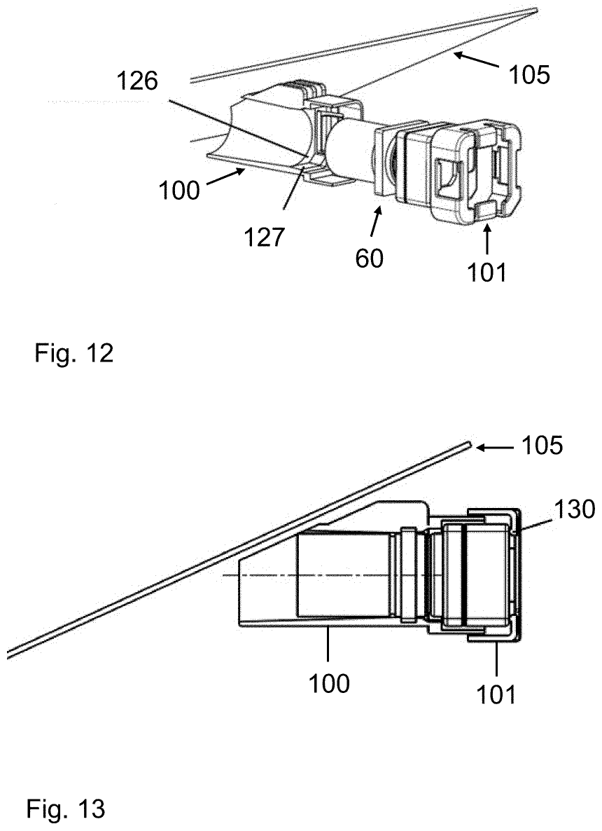

FIG. 12 shows a perspective representation, wherein the fastening/receiving device 100 is depicted sectioned vertically in the longitudinal direction. As a result, the receiving surface 126 for defining the pitch and yaw angles of the camera device 60 corresponding to the stop surface 96 can be seen in FIG. 9a, and the receiving surface(s) 127 for defining the roll angle corresponding to the stop surface(s) 97 can be seen in FIG. 9a.

FIG. 13 shows a sectional drawing of a joined-together fastening device, that is to say a fastening/receiving device 100 and fastening lid bracket 101 which hold the camera device 60. Springs 130 in the fastening lid bracket 101 cause the stop surface 96 to be pressed onto the receiving surface 126 in order to define the pitch and yaw angles of the camera device 60 with respect to the vehicle. One or more springs (not depicted) define the roll angle, in a comparable way, by pressing one or two stop surface(s) 97 parallel to the optical axis of the telephoto lens 52 of the positioning element 56 against the corresponding stop surface(s) 97.

The present disclosure has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A camera device for a vehicle, comprising:
an objective; and
an image sensor housing mechanically connected to the objective;
wherein the objective is a telephoto lens; and
wherein the telephoto lens has a positioning element which enables the camera device to be fastened in an orientation predetermined by the positioning element of the telephoto lens.

2. The camera device according to claim 1, wherein the positioning element is a flange.

3. The camera device according to claim 1, wherein the positioning element is configured as an integral part of a lens holder of the telephoto lens.

4. The camera device according to claim 1, wherein the positioning element has at least one stop surface perpendicular to an optical axis of the telephoto lens.

5. The camera device according to claim 1, wherein the positioning element has at least one stop surface parallel to an optical axis of the telephoto lens.

6. The camera device according to claim 5, wherein the positioning element has two stop surfaces approximately at right angles to one another, which both run parallel to the optical axis of the telephoto lens.

7. A fastening device for receiving and fixing a camera device, the camera device including an objective and an image sensor housing mechanically connected thereto, wherein the objective is a telephoto lens and wherein the telephoto lens has a positioning element which enables the camera device to be fastened in an orientation predetermined by the positioning element of the telephoto lens, and wherein the fastening device can be fastened to a vehicle window, and the orientation of the camera device with respect to the vehicle window is substantially defined by the connection to the positioning element of the telephoto lens of the camera device.

8. The fastening device according to claim 7, wherein the positioning element includes at least one stop surface, and wherein the fastening device further comprises at least one first spring which, in an assembled condition, causes the at least one stop surface to be pressed onto a corresponding surface of the fastening device perpendicularly to the optical axis of the camera device.

9. The fastening device according to claim 8, wherein the at least one stop surface is further defined as a plurality of stop surfaces, and wherein the fastening device further comprises at least one second spring which causes the stop surfaces to be or respectively become pressed onto one or two corresponding surfaces of the fastening device parallel to the optical axis of the camera device.
